(19) United States
(12) Patent Application Publication
(10) Pub. No.: US 2015/0158497 A1
(43) Pub. Date: Jun. 11, 2015

(54) METHOD FOR MONITORING A DRIVE OF A VEHICLE

(71) Applicant: Robert Bosch GmbH, Stuttgart (DE)

(72) Inventor: Matthias SCHUELER, Steinheim (DE)

(21) Appl. No.: 14/565,586

(22) Filed: Dec. 10, 2014

(30) Foreign Application Priority Data
Dec. 10, 2013 (DE) 10 2013 225 500.4

(51) Int. Cl. B60W 40/10

(52) U.S. Cl. CPC B60W 40/10

(57) ABSTRACT

A method is provided for monitoring a drive of a vehicle, a change in an internal energy of the vehicle being compared with a power of the vehicle to be expected.

### BACKGROUND INFORMATION

It is known that monitoring of vehicles for unintentional acceleration is carried out by continuous monitoring of torque. This is done by processing a driver's intended torque, which is determined based on the position of the accelerator pedal. Depending on the driver's intent and any additional torque requests by driver assistance systems and/or auxiliary units, a setpoint drive torque is calculated. A safety function models the calculation of the setpoint drive torque and compares the result of the modeling with the setpoint drive torque. If this comparison reveals a deviation outside of tolerable limits, then an error in the drive system of the vehicle is deduced and corresponding measures are initiated. For example, fuel injection above a certain rotational speed threshold may be suppressed.

One additional possibility is offered by acceleration monitoring of the vehicle. Acceleration monitoring may be based on the vehicle speed and acceleration ascertained from the wheel rotational speeds or, alternatively, on the signal of an acceleration sensor.

German Published Patent Application No. 10 2011 075 609 describes the use of an inertial sensor as a longitudinal acceleration sensor, which measures acceleration on the basis of a capacitive effect in a conductor, which is bent during acceleration due to its inertia. Since the gravitational force acts equally on the inertial mass, the flexible conductor and the fastening point of the conductor, gravitational acceleration is in principle not measured by this measuring concept.

One disadvantage of a comparison of an admissible acceleration with a measured actual acceleration is that all forces and torques must be converted to a comparative level. Thus, for example, the engine torque of an internal combustion engine having a transmission ratio and axle ratio and having a wheel diameter is converted into a force acting on the vehicle in the longitudinal direction, and the resulting vehicle acceleration is calculated using this force and the vehicle mass. However, the actual transmission ratio is tolerance-afflicted in the case of CVT transmissions, for example. Even with a slipping clutch in a vehicle having a manual shift or in converter operation of an automatic transmission, the actual transmission ratio is variable and is not known exactly. Furthermore, the wheel diameter is afflicted with static and dynamic tolerances. Thus, in the conversion of torques from the reference system of the engine to forces in the reference system of the vehicle, the tolerance of the forces and thus also the tolerance of the acceleration calculated therefrom are thus increased. In order for monitoring to continue to be robust, the monitoring limits must be expanded. Alternatively, an attempt may be made to minimize the increase in the tolerance by way of a complex calculation of the actual transmission ratio.

### SUMMARY

The method according to the present invention has the advantage over the related art that the drive of the vehicle may be monitored by comparing a change in an internal energy of the vehicle with an expected power of the vehicle.

It has been recognized according to the present invention that the total energy of the vehicle changes due to energy input and energy output, and thus monitoring of the vehicle for unintentional acceleration may be implemented by using an energy balance or power balance.

A drive is understood below to be a drive system, which includes one or multiple power plants plus the respective control. The drive to be monitored is advantageously the drive of a motor vehicle. In the context of the present invention, the term “power” is understood to refer to work expended per unit of time or a change in energy per unit of time, in particular a time derivation of energy. Internal energy is understood below to refer to the energy stored in a moving vehicle. Internal energy includes in particular energy forms of classical mechanics, i.e., potential energy, rotational energy, kinetic energy, the energy of a taut spring, etc. In the sense of the present invention, chemical or electrical energy stored in an energy store is not considered to be the internal energy of the vehicle.

It is advantageous to form the expected power of the vehicle from an expected drive power and an expected power loss. It is thus possible to take into account the fact that not all the power converted in a drive is reflected in the propulsion of the vehicle.

In forming the expected power of the vehicle, it is advantageous to take into account an offset. It is thus possible to increase the robustness of the method according to the present invention. In one advantageous embodiment of the present invention, the offset used in an acceleration situation may be differentiated from the offset in a deceleration situation to implement the different tolerances of a perfectly functioning system. Furthermore, in one particularly advantageous embodiment of the present invention, it is possible to take into account special situations during operation of the vehicle by varying the offset. For example, the method according to the present invention may also be employed in a start-up situation or in a tow-start situation, for example, when the vehicle is being towed, via a suitably adapted value of the offset.

It is advantageous to form the power loss to be expected from a braking power to be expected, from an air friction power to be expected and a rolling friction power to be expected. The accuracy of the method according to the present invention may thus be increased. The term “braking power” refers to the change in the energy of the vehicle, caused by application of the brakes. The term “air friction power” denotes the change in the energy of the vehicle caused by the air friction and the term “rolling friction power” denotes the change in the energy of the vehicle caused by rolling friction, for example, of the tires or by sliding friction when the wheels are locked up. In one advantageous embodiment of the present invention, the braking power, the air friction power and the rolling friction power are estimated and ascertained on the basis of vehicle-specific parameters. In one particularly advantageous embodiment of the present invention, functions and/or engine characteristic maps and/or lookup tables stored in a control unit in the vehicle are used to this end. In another advantageous embodiment of the present invention, the power loss is calculated from a braking power to be expected, an air friction power to be expected, a rolling friction power to be expected and a drive train power loss to be expected. The drive train power loss combines the types of power loss occurring in the drive train of the vehicle, for example, a power loss in a transmission or a power loss in a converter clutch.

It is advantageous to calculate the change in the internal energy of a vehicle from a change in the kinetic energy, a change in the potential energy and a change in the rotational energy of a vehicle. In one advantageous embodiment of the present invention, the change in the potential energy of a vehicle is determined with the aid of a gyroscope and/or a pressure sensor and/or a three-dimensional satellite navigation. The rotational energies of all the rotating parts of a vehicle are advantageously combined. The kinetic energy of a vehicle is advantageously determined via a measured wheel rotational speed.

It is advantageous to replace the sum of the change in the kinetic energy and the potential energy by a variable, which depends on the acceleration of the vehicle, whereby the acceleration of the vehicle is detected by a sensor. When using a suitable, essentially known acceleration sensor, the gravitational acceleration of the vehicle is not detected. The term for the sum of the kinetic energy and the potential energy is then reduced to a product of the mass of the vehicle, the speed of the vehicle and the acceleration of the vehicle, as measured by the acceleration sensor. In one particularly advantageous embodiment of the present invention, the sensor is an inertial sensor.

It is advantageous to detect an error when the change in the internal energy of the vehicle differs from the power of the vehicle to be expected by more than a predefinable value. An emergency measure may be taken in response to the error detected. For example, fuel injection into an internal combustion engine may be suppressed above a predefinable rotational speed threshold. In the case of an electric motor, suitable measures to limit the rotational speed and the torque of the electric motor may also be taken. The driver of the vehicle and/or a repair shop may be notified.

Also advantageous is a device for monitoring the drive of a vehicle, which includes means for detecting a change in internal energy, means for detecting a power of a vehicle to be expected and means for comparing the change in the internal energy of the vehicle with the power of the vehicle to be expected.

Also advantageous is a computer program which is designed or, is designed by compilation, to carry out each step of the method according to the present invention as well as an electronic memory medium in which the computer program is stored.

Also advantageous is an electronic control unit, which includes the electronic memory medium. The engine control, which is present anyway, or a vehicle control, which is often present, is used advantageously.

One exemplary embodiment of the present invention is explained in greater detail below on the basis of the accompanying drawings.

### BRIEF DESCRIPTION OF THE DRAWINGS

FIG. 1 shows a schematic diagram of a vehicle including a device for carrying out the method according to the present invention.

FIG. 2 shows a schematic diagram of a sequence of the method according to the present invention.

### DETAILED DESCRIPTION

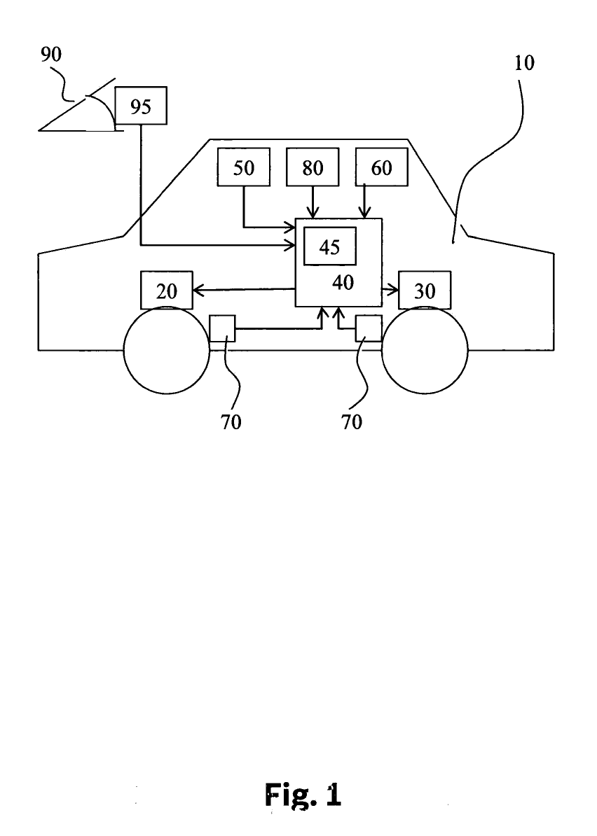

FIG. 1 shows a schematic diagram of a vehicle 10 including a device for carrying out the method according to the present invention. Vehicle 10 has at least one power plant 20, 30, for example, an internal combustion engine 20 and/or an electric motor 30. The at least one power plant 20, 30 is controlled by an engine control 40. Engine control 40 includes an electronic memory medium 45. In one advantageous embodiment of the present invention, the at least one power plant 20, 30 includes a device for detecting the rotational speed of the at least one power plant 20, 30.

The vehicle also has a unit for supplying the change in the potential energy of vehicle 10. The unit for supplying the change in potential energy 50 may include a sensor, in particular a gyroscope, which detects an angle of inclination of vehicle 10. Alternatively, the unit for supplying the change in the potential energy 50 may also include a pressure sensor and may thus supply the change in the potential energy of the vehicle, based on the barometric height formula. Alternatively, the unit for supplying the change in potential energy 50 may also include a satellite navigation unit and may thus supply the change in potential energy based on three-dimensional navigation data.

An acceleration sensor 60 detects the acceleration of vehicle 10 and transmits a signal representing the acceleration to the engine control. In one particularly advantageous embodiment of the present invention, the acceleration sensor 60 is an acceleration sensor having a seismic test mass, which does not in principle detect gravitational accelerations on vehicle (10). If the acceleration sensor 60 is an acceleration sensor having a seismic test mass, then the unit for supplying the change in potential energy 50 may be omitted. Likewise, at least one wheel rotational speed sensor 70 is present, which measures the rotational speed of one wheel of vehicle 10 and sends a corresponding wheel rotational speed signal to engine control 40, where the speed of the vehicle may be determined from the wheel rotational speed signal, for example. In one particularly advantageous embodiment of the present invention, the sensor 60 is an inertial sensor.

Vehicle 10 may also include one or more driver assistance systems 80, for example, active cruise control, which influence the longitudinal movement of the vehicle. However, the presence of a driver assistance system 80 is not necessary to carry out the method according to the present invention.

Vehicle 10 also includes an operating element (90) for adjusting a torque desired by the driver as well as a sensor 95, which reads out the position of the operating element 90 and outputs to engine control 40 a signal characterizing the position of operating element 90. Operating element 90 is advantageously an accelerator pedal. Alternatively, however, the operating element may also be the operating element of a cruise control.

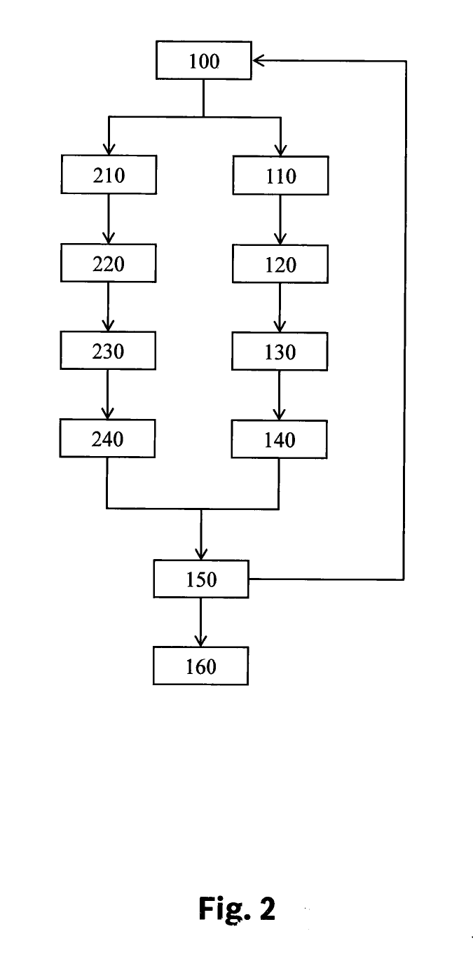

FIG. 2 shows a schematic diagram of a sequence of the method according to the present invention. The method according to the present invention starts in step 100. Starting from step 100, in a first branch, including steps 110, 120, 130 and 140, the power of the vehicle to be expected is determined, while in a second branch, including steps 210, 220, 230 and 240, the change in the internal energy of the vehicle is determined Alternatively, however, the method according to the present invention may also be carried out by using only one branch, by carrying out only the steps of the first branch, and then the steps of the second branch, for example. It is likewise possible to carry out the individual steps of the first branch and the individual steps of the second branch in alternation.

In step 110, the signal supplied by sensor 95 is read out and thus a drive power of the vehicle to be expected is determined In step 110, the signal of a driver assistance system 80, which influences the longitudinal movement of the vehicle, may advantageously also be taken into account. The power to be expected may be determined via a previous determination of a setpoint torque, which is then converted into a power to be expected.

In step 120, the power loss to be expected is calculated. In one advantageous embodiment of the present invention, the power loss to be expected is calculated from a braking power to be expected, an air friction power to be expected and a rolling friction power to be expected. In one particularly advantageous embodiment of the present invention, the power loss is formed from a braking power to be expected, an air friction power to be expected, a rolling friction power to be expected and a drive train power loss to be expected. Power losses occurring in the drive train of the vehicle are combined in the drive train power loss, for example, a power loss in a transmission or a power loss in a converter clutch. Since the vehicle mass, the relative air speed and the coefficients of friction characterizing the rolling friction are not known exactly, the air friction power to be expected, the braking power to be expected and the rolling friction power to be expected and optionally the drive train power loss to be expected are estimated. Suitable estimation functions and/or engine characteristic maps may be stored in the electronic memory medium 45 of engine control 40.

In step 130, the offset of the power of the vehicle to be expected is determined. The offset is an additive contribution to the power of the vehicle to be expected, which may have a positive or a negative sign. The offset is used to ensure the robustness of the monitoring, despite the prevailing tolerances and inaccuracies. The offset may even depend on the operating situation of the vehicle. If the vehicle is monitored for inadmissible acceleration, the offset may assume a different value than if the vehicle is monitored for an inadmissible deceleration of the vehicle. For treatment of special situations, such as tow-starting of the vehicle, for example, another offset value may be provided. If the offset value in such a case is selected to be large enough, it is possible for the method according to the present invention to be also used when there is a contribution toward the power balance, which is made by an external towing vehicle, for example. The values to be used for the offset are advantageously determined within the context of an application of the method and are stored in electronic memory medium 45 of engine control 40.

In step 140, the power of the vehicle to be expected is calculated from the previously determined contributions. The power of the vehicle to be expected is advantageously calculated by subtracting the braking power to be expected, the air friction power to be expected and the rolling friction power to be expected from the drive power to be expected and adding the offset from step 130. Since the offset from step 130 may also have a negative sign, the power of the vehicle to be expected may also be reduced by addition of the offset. Individual terms contributing toward the power of the vehicle to be expected may also be replaced by the value zero, for example, when the required sensor data and/or estimated values cannot be supplied.

In step 210, the mass of the vehicle is estimated. For example, an empty mass or an additional total weight of the vehicle may be used as the starting point for an estimation, this total weight or empty mass preferably being supplemented by a correction mass, which may be estimated from the driving dynamics of the vehicle, for example. It is likewise possible to measure the mass of the vehicle if a suitably designed sensor is present in the vehicle. Depending on the type of monitoring or the driving situation, different masses for the vehicle may be assumed in step 210. If the actual vehicle mass is not known and if there is no suitable estimate, a minimum vehicle mass may be used when monitoring for inadmissible acceleration since the change in the internal energy is greater when the vehicle mass is high than when it is low. If the change in the internal energy of the vehicle, which has been calculated for a minimum mass, is greater than the power of the vehicle to be expected, then this also applies to an actual mass, which might be greater than the minimum mass. Accordingly a maximum vehicle mass may be used when monitoring for inadmissible deceleration.

In step 220, the wheel rotational speed is read out by a sensor 70 on at least one of the wheels of the vehicle. Alternatively, the wheel rotational speed may be supplied by another control unit. If an acceleration sensor 60 is present in the vehicle, it is also read out.

In step 230, the change in the potential energy, the change in the kinetic energy and the change in the rotational energy of the vehicle are calculated. The change in the rotational energy of the vehicle is calculated as the sum of the change of the rotational energy of different rotating components of the vehicle, the product of the moment of inertia, the angular velocity and the gradient of the angular velocity being determined for each component. The angular velocity and the gradient of the angular velocity may be calculated from measured variables, for example, from a measured engine speed. If a direct measured variable is not available for a certain rotating part of the vehicle, then the fact that all the rotating parts in the vehicle are often rotating with a known transmission ratio is utilized. The angular velocity of the camshaft, for example, may be calculated from the angular velocity of the crankshaft. However, the contributions to the change in the rotational energy of the vehicle of preferably many rotating parts are advantageously combined, and an effective moment of inertia, which is made up of the moments of inertia of the individual rotating parts in a suitable manner, is used. In step 230 in particular, the contributions of the wheels and the contributions of all power plants 20, 30 of the vehicle are taken into account.

The change in the kinetic energy is determined by calculating the product of a suitable vehicle mass, the speed of the vehicle and the acceleration of the vehicle. If there is no acceleration sensor 60 in the vehicle, then the speed of the vehicle and the acceleration of the vehicle are calculated from the wheel rotational speed ascertained in step 220.

The change in the potential energy of the vehicle is supplied by the unit for supplying the change in the potential energy of vehicle 50. The change in the potential energy of the vehicle may be determined by using a position sensor. Alternatively, the unit for supplying the change in the potential energy of the vehicle 50 may include a pressure sensor, and the change in the potential energy of the vehicle may be determined with the aid of the barometric height formula. Alternatively, the unit for supplying the change in the potential energy of the vehicle 50 may also include a GPS module, and the change in the potential energy of the vehicle may be calculated with the aid of three-dimensional satellite navigation.

If there is an acceleration sensor 60 having a seismic test mass, then gravity will act equally on the test mass of the sensor and on the suspension of the test mass. Such a sensor in principle detects only an acceleration of the vehicle minus gravitational influences. The sum of the change in the kinetic energy and the change in the potential energy of the vehicle is simplified, when using an acceleration sensor having a seismic test mass, to the product of the vehicle mass, the vehicle speed and the acceleration measured by the sensor. It is thus no longer necessary to calculate the change in potential energy separately.

In step 240, the change in the internal energy of the vehicle is calculated by calculating a sum of the change in the kinetic energy, the change in the potential energy and the change in the rotational energy of the vehicle. If an acceleration sensor 60 having a seismic test mass is used, then the product of vehicle mass, vehicle speed and vehicle acceleration, measured by an acceleration sensor, is used to calculate the change in internal energy of the vehicle by adding it to the change in rotational energy of the vehicle.

In step 150, the change in the internal energy of the vehicle is compared with the power of the vehicle to be expected. If this comparison reveals that the change in internal energy of the vehicle matches the power of the vehicle to be expected within predefinable limits, then the method according to the present invention is started again in step 100. If the comparison reveals that the change in internal energy of the vehicle does not match the power of the vehicle to be expected within predefinable limits, then an error is detected in step 160 and suitable measures are taken. Suitable measures may include limiting the rotational speed of the at least one power plant of the vehicle and notifying the driver or a repair shop.

What is claimed is:

1. A method for monitoring a drive of a vehicle, comprising:
comparing a change in an internal energy of the vehicle with a power of the vehicle to be expected.

2. The method as recited in claim 1, further comprising:
calculating the power of the vehicle to be expected from a drive power to be expected and a power loss to be expected.

3. The method as recited in claim 2, wherein an offset is taken into account to calculate the power of the vehicle to be expected.

4. The method as recited in claim 2, further comprising:
forming the drive power to be expected from at least one of a signal representing an intent of the driver and a signal of a driver assistance system that influences a longitudinal movement of the vehicle.

5. The method as recited claim 2, further comprising:
forming the power loss to be expected from a braking power to be expected, an air friction power to be expected, and a rolling friction power to be expected.

6. The method as recited in claim 1, further comprising:
forming the change in the internal energy of the vehicle from a change in a kinetic energy, a change in a potential energy, and a change in a rotational energy of the vehicle.

7. The method as recited in claim 6, further comprising:
detecting an acceleration of the vehicle by a sensor; and
replacing a sum of the change in the kinetic energy and the change in the potential energy by a variable that depends on the acceleration of the vehicle.

8. The method as recited in claim 1, further comprising:
detecting an error when the change in the internal energy of the vehicle differs from the power of the vehicle to be expected by more than a predefined value.

9. A device for monitoring a drive of a vehicle, comprising:
an arrangement for detecting a change in an internal energy of the vehicle;
an arrangement for detecting a power of the vehicle to be expected; and
an arrangement for comparing the internal energy of the vehicle with the power of the vehicle to be expected.

10. A computer program to carry out a method for monitoring a drive of a vehicle, comprising:
comparing a change in an internal energy of the vehicle with a power of the vehicle to be expected.

11. An electronic memory medium on which a computer program is stored, the computer program carrying out a method for monitoring a drive of a vehicle, comprising:
comparing a change in an internal energy of the vehicle with a power of the vehicle to be expected.

12. An electronic control unit, comprising:
an electronic memory medium on which a computer program is stored, the computer program carrying out a method for monitoring a drive of a vehicle, comprising:
comparing a change in an internal energy of the vehicle with a power of the vehicle to be expected.
